(19) United States
(12) Patent Application Publication
(10) Pub. No.: US 2018/0216395 A1
(43) Pub. Date: Aug. 2, 2018

(54) METHOD AND APPARATUS FOR CONTROLLING MOVEMENT OF LIFTGATE

(71) Applicant: GM GLOBAL TECHNOLOGY OPERATIONS LLC, Detroit, MI (US)

(72) Inventors: Mohammad Naserian, Windsor (CA); Allan Lewis, Windsor (CA); Shuqing Zeng, Sterling Heights, MI (US)

(21) Appl. No.: 15/420,137

(22) Filed: Jan. 31, 2017

(51) Int. Cl. E05F 15/70; B60Q 1/00; B60Q 1/26; B60J 5/10

(52) U.S. Cl. CPC E05F 15/70; B60Q 1/0023; B60Q 1/2661; E05Y 2900/532; E05Y 2400/44; E05Y 2400/45; B60J 5/101

(57) ABSTRACT

A method and apparatus for controlling movement of a liftgate are provided. The method includes: capturing an image of a pattern on a surface; determining a distance between the liftgate and the surface based on the image of the pattern; and controlling a movement of the liftgate based on the determined distance.

Apparatuses and methods consistent with exemplary embodiments relate to controlling the movement of liftgate. More particularly, apparatuses and methods consistent with exemplary embodiments relate to addressing potential collisions with obstacles when a liftgate is moving.

### SUMMARY

One or more exemplary embodiments provide a method and an apparatus that control a movement of the liftgate based on a pattern detected on a surface. More particularly, one or more exemplary embodiments provide a method and an apparatus that control a movement of the liftgate by determining the distance between the liftgate and a surface based on a pattern projected onto a surface.

According to an aspect of an exemplary embodiment, a method for controlling movement of a liftgate of a vehicle is provided. The method includes: projecting a pattern of light on a surface near a liftgate; capturing an image of the pattern of light; determining a distance between the liftgate and the surface based on the image of the pattern of light; and controlling a movement of the liftgate based on the determined distance.

The method may further include detecting a signal to start movement of the liftgate, The projecting the pattern of light may be performed in response to detecting the signal.

The image of the pattern of light may captured by a camera mounted on the liftgate.

The determining the distance between the liftgate and the surface may include determining whether the determined distance between the surface and the liftgate is less than a predetermined threshold distance.

The controlling the movement of the liftgate may include opening the liftgate if the determined distance is less than the predetermined threshold distance.

The controlling the movement of the liftgate may include stopping movement of the liftgate if the determined distance is greater than or equal to the predetermined threshold distance.

The projected pattern may include at least one from among lines, polygons and circles.

The determining the distance between the liftgate and the surface may include determining whether a size in pixels of a dimension of at least part of the projected pattern is less than a predetermined threshold number of pixels.

According to an aspect of an exemplary embodiment, an apparatus for controlling movement of a liftgate is provided. The apparatus includes: at least one memory comprising computer executable instructions; and at least one processor configured to read and execute the computer executable instructions. The computer executable instructions cause the at least one processor to: project a pattern of light on a surface near a liftgate; capture an image of the pattern of light; determine a distance between the liftgate and the surface based on the image of the pattern of light; and control a movement of the liftgate based on the determined distance.

The computer executable instructions may cause the at least one processor to detect a signal to start movement of the liftgate, and cause the at least one processor to project the pattern of light after detecting the signal.

The apparatus may further include: a camera mounted on the liftgate. The camera may be configured to capture the image of the pattern of light.

The computer executable instructions may cause the at least one processor to determine the distance between the liftgate and the surface by determining whether the determined distance between the surface and the liftgate is less than a predetermined threshold distance

The computer executable instructions may cause the at least one processor to control the movement of the liftgate by opening the liftgate if the determined distance is less than the predetermined threshold distance.

The computer executable instructions may cause the at least one processor to control the movement of the liftgate by stopping movement of the liftgate if the determined distance is greater than or equal to the predetermined threshold distance.

The apparatus may further include a light emitting diode configured to emit the projected pattern. The projected pattern may include at least one from among lines, polygons and circles.

The computer executable instructions may cause the at least one processor to determine the distance between the liftgate and the surface by determining whether a size of a dimension of at least part of the projected pattern in pixels is less than a predetermined threshold number of pixels.

According to an aspect of an exemplary embodiment, a non-transitory computer readable medium comprising computer executable instructions executable by a processor to perform a method for controlling movement of a liftgate is provided. The method includes: capturing an image of a pattern on a surface; determining a distance between the liftgate and the surface based on the captured image; and controlling a movement of the liftgate based on the determined distance.

The determining the distance between the liftgate and the surface may include determining whether a size in pixels of a dimension of at least part of the pattern is less than a predetermined threshold number of pixels.

The determining the distance between the liftgate and the surface may include determining whether the determined distance between the surface and the liftgate is less than a predetermined threshold distance, and the controlling the movement of the liftgate may include opening the liftgate if the determined distance is less than the predetermined threshold distance and stopping movement of the liftgate if the determined distance is greater than or equal to the predetermined threshold distance.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that controls movement of a liftgate according to an exemplary embodiment;

FIG. 2 shows a flowchart for a method of controlling the movement for a liftgate according to an exemplary embodiment;

FIG. 3 shows a flowchart for a method of controlling the movement for a liftgate according to an exemplary embodiment;

FIG. 4 shows illustrations of example patterns used to detect a distance between a liftgate and a surface according to an aspect of an exemplary embodiment; and

FIG. 5 shows illustrations of liftgates and light sources according to an aspect of an exemplary embodiment.

### DETAILED DESCRIPTION OF EXEMPLARY EMBODIMENTS

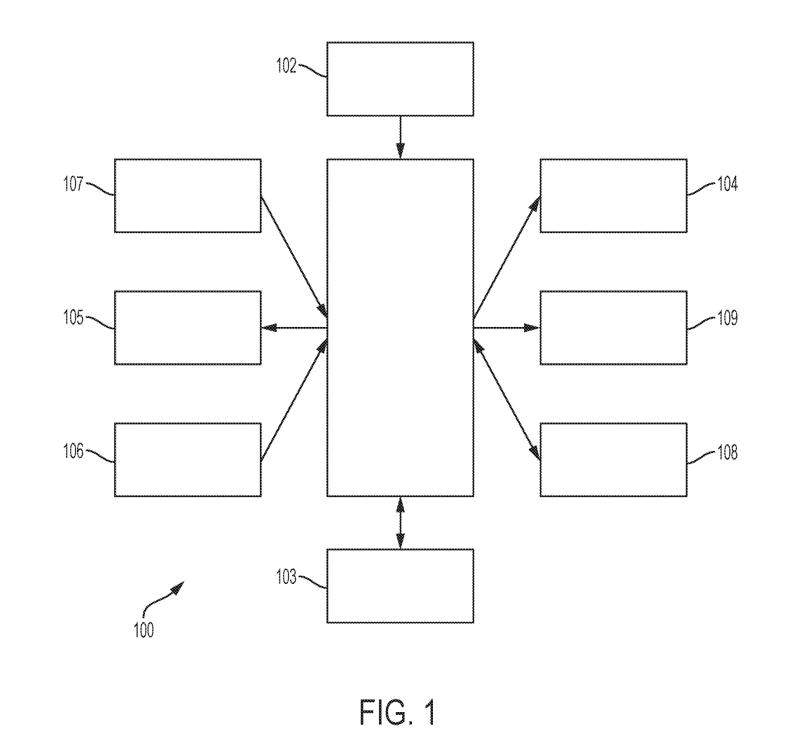

An apparatus and method that control movement of a liftgate will now be described in detail with reference to FIGS. 1-5 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Access to openings, such as those on a vehicle, is usually controlled by a door, window, or liftgate. For example, a liftgate may control access to a trunk of a vehicle such as a sport utility vehicle or a hatchback. The liftgate may be opened by actuating a motor through the push of a button in a vehicle, a mechanical device, or other device. Oftentimes, there may be obstacles obstructing the trajectory of a moving liftgate or door. If the movement of the liftgate or door causes the liftgate or door to strike the obstacle, it may cause damage to the liftgate or the obstacle.

In one example, a liftgate that is swinging upwards may be potentially hit a ceiling in a place with a low clearance. In another example, the liftgate or door may potentially strike a wall while opening because of a lack of clearance between the liftgate or the door and the wall. Generally, a human operator can manually control the movement of the liftgate or door to prevent them from hitting a wall or a ceiling. However, in cases where a human operator is not present or in other cases where it is difficult to control the motion of a liftgate or door to prevent it from hitting an obstacle, a system that detects potential obstacles and controls the motion of the liftgate or door to prevent collisions may address these issues.

FIG. 1 shows a block diagram of an apparatus that controls movement of a liftgate 100 according to an exemplary embodiment. As shown in FIG. 1, the apparatus that controls movement of a liftgate 100, according to an exemplary embodiment, includes a controller 101, a power supply 102, a storage 103, an output 104, a pattern emitter 105, a user input 106, a rear facing camera 107, a communication device 108, and a liftgate motor 109. However, the apparatus that controls movement of a liftgate 100 is not limited to the aforementioned configuration and may be configured to include additional elements and/or omit one or more of the aforementioned elements. The apparatus that controls movement of a liftgate 100 may be implemented as part of a vehicle, as a standalone component, as a hybrid between an on vehicle and off vehicle device, or in another computing device.

The controller 101 controls the overall operation and function of the apparatus that controls movement of a liftgate 100. The controller 101 may control one or more of a storage 103, an output 104, a pattern emitter 105, a user input 106, a rear facing camera 107, a communication device 108, and a liftgate motor 109 of the apparatus that controls movement of a liftgate 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the pattern emitter 105, the user input 106, the rear facing camera 107, communication device 108, and the liftgate motor 109 of the apparatus that controls movement of a liftgate 100. The information may be sent and received via a bus or network, or may be directly read or written to/from one or more of the storage 103, the output 104, the user input 106, the rear facing camera 107, and the communication device 108 of the apparatus that controls movement of a liftgate 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the pattern emitter 105, the user input 106, the rear facing camera 107, the communication device 108, and the liftgate motor 109, of the apparatus that controls movement of a liftgate 100. The power supply 102 may include one or more from among a battery, an outlet, a capacitor, a solar energy cell, a generator, a wind energy device, an alternator, etc.

The storage 103 is configured for storing information and retrieving information used by the apparatus that controls movement of a liftgate 100. The storage 103 may be controlled by the controller 101 to store and retrieve information received from the rear facing camera 107. The information may include information on a pattern detected by the rear facing camera 107 and/or a distance between a vehicle liftgate or door and a surface on which the pattern is emitted. In addition, the storage 103 may store image information provided by rear facing camera 107 that is analyzed to determine a distance between a vehicle liftgate or door and a surface such as a wall, ceiling, or other object. The storage 103 may store information to control the liftgate motor 109 to control the movement of the liftgate to stop, start, or adjust a position of the liftgate. The storage 103 may also include the computer instructions configured to be executed by a processor to perform the functions of the apparatus that controls movement of a liftgate 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that controls movement of a liftgate 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output a notification including one or more from among an audible notification, a light notification, and a display notification. The notification may include information notifying of a potential collision between a door and a liftgate of a vehicle and a surface, a ceiling, an object, etc. According to one example, the output 104 may output an image showing a distance between a door and liftgate of a vehicle and a surface, ceiling, object, etc.

The pattern emitter 105 may include one or more from among a laser emitter, a light emitting diode, an illumination device, a light, an infrared emitter, a taillight, etc. The pattern emitter 105 may be configured to emit a pattern onto a surface, object, or obstacle, etc. Examples of a surface, object, or obstacle may include a wall, ceiling, column, etc. The pattern may include lines, polygons, or circles, etc.

The user input 106 is configured to provide information and commands to the apparatus that controls movement of a liftgate 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to activate the apparatus that controls movement of a liftgate 100. For example, a setting to turn the system on or off may be selected by an operator via user input 106.

The rear facing camera 107 may include one or more from among a plurality of cameras including a camera, an infrared camera, etc. The rear facing camera 107 may provide one or more images that may be analyzed to determine a distance between a vehicle, a vehicle door, or a vehicle liftgate and a ceiling, a wall, a column, or other obstacle.

The communication device 108 may be used by apparatus that controls movement of a liftgate 100 to communicate with various types of external apparatuses according to various communication methods. The communication device 108 may be used to send/receive information on a pattern detected by the rear facing camera 107 or a distance between a vehicle liftgate or door and a surface such as a wall, ceiling, or other object to/from the controller 101 of the apparatus that controls movement of a liftgate 100.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee.

The liftgate motor 109 may be an electric motor that receives control input from the controller 101. The liftgate motor 109 may be connected to the liftgate such that it controls movement of the liftgate to open, close, or adjust a position of the liftgate. The liftgate motor may be an electric motor. According to another example, the liftgate motor 109 may be an electric motor that may be connected to a door such that it controls movement of the door to open, close, or adjust a position of the door.

In one example, the controller 101 of the apparatus that controls movement of a liftgate 100 may be configured to project a pattern of light on a surface near a liftgate, capture an image of the pattern of light, determine a distance between the liftgate and the surface based on the image of the pattern of light, and control a movement of the liftgate based on the determined distance.

The controller 101 of the apparatus that controls movement of a liftgate 100 may be configured to project the pattern of light is performed after detect a signal to start movement of the liftgate. In addition, the controller 101 of the apparatus that controls movement of a liftgate 100 may be configured to determine the distance between the liftgate and the surface by determining whether the determined distance between the surface and the liftgate is less than a predetermined threshold distance.

The controller 101 of the apparatus that controls movement of a liftgate 100 may be configured to control the movement of the liftgate by opening the liftgate if the determined distance is less than the predetermined threshold distance. The controller 101 of the apparatus that controls movement of a liftgate 100 may be configured to control the movement of the liftgate by stopping movement of the liftgate if the determined distance is greater than or equal to the predetermined threshold distance.

The controller 101 of the apparatus that controls movement of a liftgate 100 may be configured to determine the distance between the liftgate and the surface by determining whether a size of a dimension of at least part of the projected pattern in pixels is less than a predetermined threshold number of pixels.

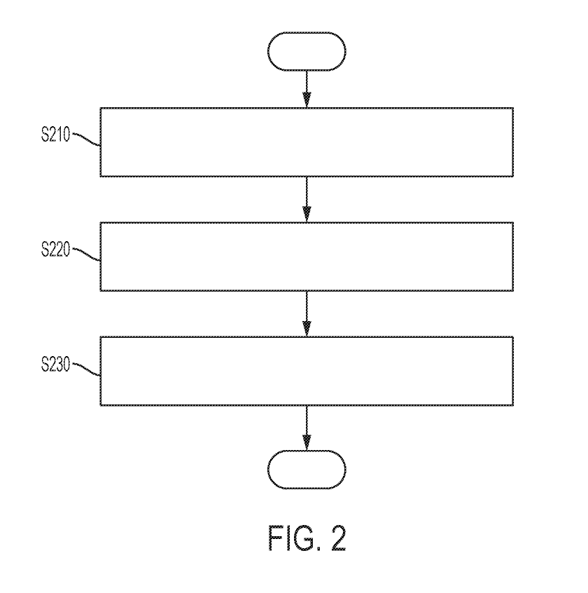

FIG. 2 shows a flowchart for a method of controlling the movement for a liftgate according to an exemplary embodiment. The method of FIG. 2 may be performed by the apparatus that controls movement of a liftgate 100 or may be encoded into a computer readable medium as instructions that are executable by a computer to perform the method.

Referring to FIG. 2, an image of a pattern on a surface is captured in operation S210. A distance between liftgate and surface is determined based on the captured image in operation S220. In operation S230, a movement of the liftgate is controlled based on determined distance.

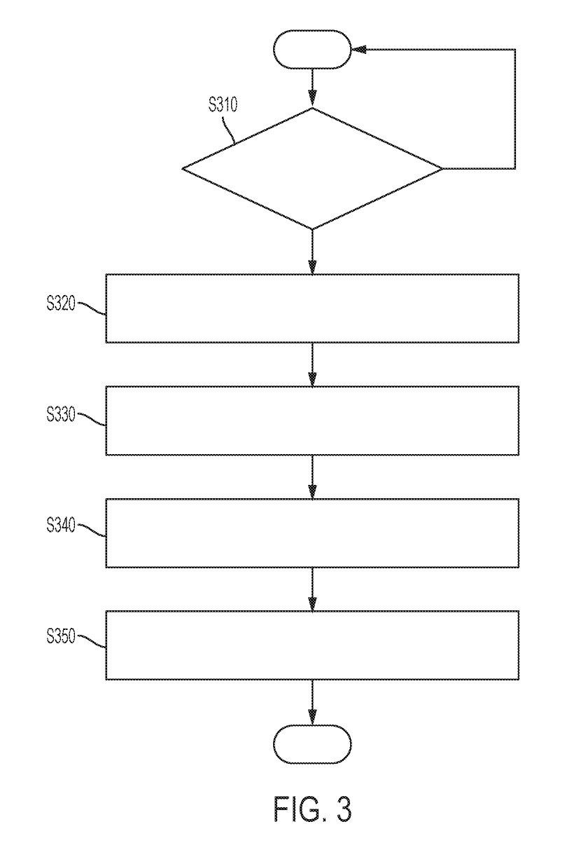

FIG. 3 shows a flowchart for a method of controlling the movement for a liftgate according to an aspect of an exemplary embodiment. The method of FIG. 3 may be performed by the apparatus that controls movement of a liftgate 100 or may be encoded into a computer readable medium as instructions that are executable by a computer to perform the method.

Referring to FIG. 3, a signal to start movement of the liftgate is detected in operation S310. The signal may be received in response to a selection of button to close a liftgate by an operator of a liftgate. In operation S320, a pattern of light is projected on a surface near liftgate or door. The pattern of light may be projected by a tail light or other light emitting device.

In operation S330, an image of a pattern of light is captured by a camera or other imagining device. Then, in operation S350, a distance between a liftgate or a door and a surface based on an image of a pattern of light is determined. In operation S350, a movement of a liftgate is controlled based on a determined distance.

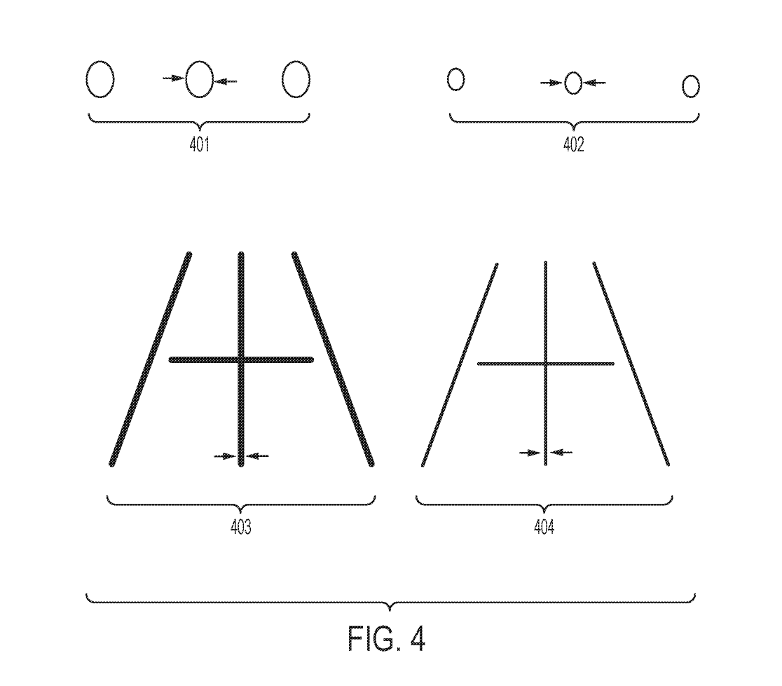

FIG. 4 shows illustrations of example patterns used to detect a distance between a liftgate and a surface according to an aspect of an exemplary embodiment. Referring to FIG. 4, a pattern produced by pattern emitter 105 is emitted onto a surface. The pattern may be a pattern of circles as shown in example patterns 401 and 402. The size or diameter of the circles varies as the distance between the liftgate and a surface changes. The size or diameter of the circles can be measured in pixels from an image of the pattern to determine the distance between the liftgate and the surface. The number of pixels may then be used to calculate a real life size of the pattern, which can be used to determine the distance or may be used calculate a real life distance.

According to another example, the pattern may be a pattern of lines as shown in example patterns 403 and 404. The width of the lines varies as the distance between the liftgate or door and a surface changes. The width of the lines can be measured in pixels from an image of the pattern to determine the distance between the liftgate or door and the surface. In addition, the projected pattern is not limited to lines and circles discussed above, but may include any combination of lines, polygons or circles.

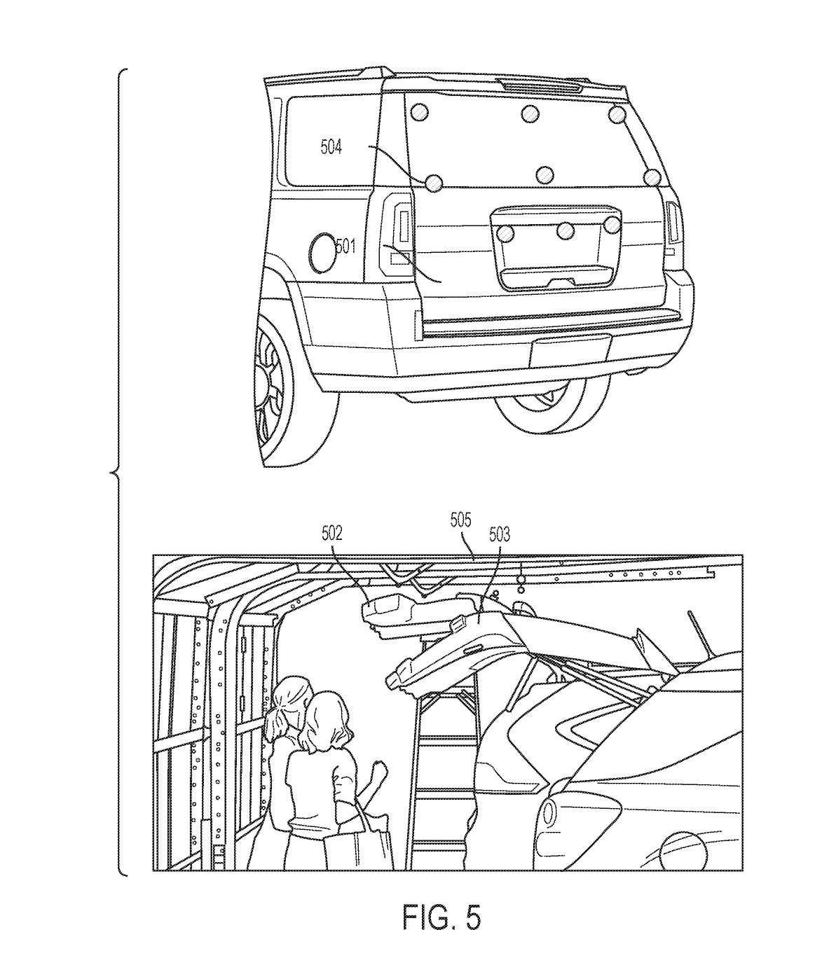

FIG. 5 shows illustrations of liftgates and light sources according to an aspect of an exemplary embodiment. Referring to FIG. 5, potential locations 504 for pattern emitter 105 are shown on a liftgate 501. There may be one or more of pattern emitter 105 placed on the liftgate 501. However, the pattern emitters 105 may be placed in other locations on a vehicle. Moreover, the pattern emitter may be embodied as one or more from among rear vehicle lights such as brake lights, taillights, or reverse lights.

Liftgate 502 is an example of liftgate with uncontrolled movement that may hit a ceiling 505. Liftgate 503 is an example of a liftgate with controlled movement that detects a ceiling 505 and stops movement of the liftgate before it hits a ceiling 505.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for controlling movement of a liftgate of a vehicle, the method comprising:
projecting a pattern of light on a surface near a liftgate;
capturing an image of the pattern of light;
determining a distance between the liftgate and the surface based on the image of the pattern of light; and
controlling a movement of the liftgate based on the determined distance.

2. The method of claim 1, further comprising detecting a signal to start movement of the liftgate,
wherein the projecting the pattern of light is performed in response to detecting the signal.

3. The method of claim 1, wherein the image of the pattern of light is captured by a camera mounted on the liftgate.

4. The method of claim 1, wherein the determining the distance between the liftgate and the surface comprises determining whether the determined distance between the surface and the liftgate is less than a predetermined threshold distance.

5. The method of claim 4, wherein the controlling the movement of the liftgate comprises opening the liftgate if the determined distance is less than the predetermined threshold distance.

6. The method of claim 5, wherein the controlling the movement of the liftgate comprises stopping movement of the liftgate if the determined distance is greater than or equal to the predetermined threshold distance.

7. The method of claim 1, wherein the projected pattern comprises at least one from among lines, polygons and circles.

8. The method of claim 7, wherein the determining the distance between the liftgate and the surface comprises determining whether a size in pixels of a dimension of at least part of the projected pattern is less than a predetermined threshold number of pixels.

9. A non-transitory computer readable medium comprising computer executable instructions executable by a processor to perform the method of claim 1.

10. An apparatus for controlling movement of a liftgate, the apparatus comprising:
at least one memory comprising computer executable instructions; and
at least one processor configured to read and execute the computer executable instructions, the computer executable instructions causing the at least one processor to:
project a pattern of light on a surface near a liftgate;
capture an image of the pattern of light;
determine a distance between the liftgate and the surface based on the image of the pattern of light; and
control a movement of the liftgate based on the determined distance.

11. The apparatus of claim 10, wherein the computer executable instructions cause the at least one processor to detect a signal to start movement of the liftgate, and
wherein the computer executable instructions cause the at least one processor to project the pattern of light after detecting the signal.

12. The apparatus of claim 10, further comprising:
a camera mounted on the liftgate,
wherein the camera is configured to capture the image of the pattern of light.

13. The apparatus of claim 10, wherein the computer executable instructions cause the at least one processor to determine the distance between the liftgate and the surface by determining whether the determined distance between the surface and the liftgate is less than a predetermined threshold distance

14. The apparatus of claim 13, wherein the computer executable instructions cause the at least one processor to control the movement of the liftgate by opening the liftgate if the determined distance is less than the predetermined threshold distance.

15. The apparatus of claim 14, wherein the computer executable instructions cause the at least one processor to control the movement of the liftgate by stopping movement of the liftgate if the determined distance is greater than or equal to the predetermined threshold distance.

16. The apparatus of claim 10, further comprising a light emitting diode configured to emit the projected pattern,
wherein the projected pattern comprises at least one from among lines, polygons and circles.

17. The apparatus of claim 16, wherein the computer executable instructions cause the at least one processor to determine the distance between the liftgate and the surface by determining whether a size of a dimension of at least part of the projected pattern in pixels is less than a predetermined threshold number of pixels.

18. A non-transitory computer readable medium comprising computer executable instructions executable by a processor to perform a method for controlling movement of a liftgate, the method comprising:
capturing an image of a pattern on a surface;
determining a distance between the liftgate and the surface based on the captured image; and
controlling a movement of the liftgate based on the determined distance.

19. The non-transitory computer readable medium of claim 18, wherein the determining the distance between the liftgate and the surface comprises determining whether a size of a dimension in pixels of at least part of the pattern is less than a predetermined threshold number of pixels.

20. The non-transitory computer readable medium of claim 18, wherein the determining the distance between the liftgate and the surface comprises determining whether the determined distance between the surface and the liftgate is less than a predetermined threshold distance, and
wherein the controlling the movement of the liftgate comprises opening the liftgate if the determined distance is less than the predetermined threshold distance and stopping movement of the liftgate if the determined distance is greater than or equal to the predetermined threshold distance.
